(19) United States
(12) Patent Application Publication
(10) Pub. No.: US 2018/0311112 A1
(43) Pub. Date: Nov. 1, 2018

(54) HOLDER FOR FLUID DELIVERY SYSTEM

(71) Applicant: Helpful Baby Products Ltd., Harrogate Yorkshire (GB)

(72) Inventor: Timothy Moor, Huntingdon Cambridgeshire (GB)

(21) Appl. No.: 15/766,416

(22) PCT Filed: Oct. 7, 2016
(86) PCT No.: PCT/EP2016/074025

§ 371 Date: Apr. 6, 2018

(30) Foreign Application Priority Data
Oct. 7, 2015 (GB) 1517743.9

(51) Int. Cl. A61J 11/00; A61J 9/00; A61J 9/08; A61J 11/04

(52) U.S. Cl. CPC A61J 11/0085; A61J 11/04; A61J 9/085; A61J 9/005

(57) ABSTRACT

A holder system comprises a holder (1), provided with a seal (2) and an external circumferential band (3). A slip ring (4) is provided which can be pressed against the seal (2) in the direction shown by the arrows (5) provided on the slip ring to form a snap fit with the holder. Above the holder is a collar (6) designed to engage with the upper surface (7) of the holder. FIG. 2 shows a teat (8) provided with a band (9) at its lower end which engages with a lug inside the holder (1) to provide a tight seal, the cap (10) is placeable in the collar. The attachment of the collar (6) to the holder (1) secures the teat in position.

The present invention relates to improvements in or relating to holders for containers and in particular to holders that provide attachment, handling and delivery mechanism for the contents of containers such as pouches or sachets by attachment thereto. The invention is particularly useful with liquid foods such as infant foods particularly milk which can be supplied in hermetically sealed pouches or sachets perhaps as a powder and which can be opened and attached to the holder for handling during the provision of water to make up the food and also to provide delivery means and enable handling of the container for delivery of the liquid so produced to the infant.

Baby bottle systems comprising a hermetically sealed pouch for infant food sealed to a holder which can provide a hermetic seal, and a cap which can contain a collapsed teat which can be released to provide the delivery mechanism for the infant food are known.

PCT Publication WO 2005/107680 provides a fluid container which can be flat packed when empty, can be provided pre-sterilised, can be readily filled and which is disposable after use and provides a flat packed evacuated and/or folded container comprising a flexible bag or pouch which is welded to a sealed cover. Removal of the cover provides an opening to enable filling of the container, the opening may contain a non-return valve. The container may be provided with a removable cover sealing system comprising a ring pull or thin film seal and/or a fluid delivery tube through which material can be taken from the container such as through the drinking of the contents. The container may also be provided with a cap or a lid.

The container of WO 2005/107680 may be sterilised prior to flat packing and may also be enclosed in a hermetically sealed bag or envelope to reduce the risk of contamination prior to use. The bag or envelope may conveniently be made of material that provides protection for the container and any contents against ultra violet radiation.

In WO 2010/121800 we describe a collapsible fluid container and improvements in or relating to the fluid containers such as those described in WO 2005/107680 comprising a pouch that is hermetically welded to a holder which in turn enables the pouch to be sealed and also provides a system for the delivery of the contents of the container when in use. Such as for example the teat of a baby bottle.

One disadvantage of these previous systems is that both the holder and the pouch must be disposed of after use which is wasteful and also because the holder and the pouch are derived from different plastic materials and they are welded to each other the entire system cannot be easily recycled. There is also a need for a holder that can be used with a variety of pouches or sachets to avoid the need to provide a new holder with every pouch or sachet.

The present invention provides a holder system for a pouch or sachet that overcomes these disadvantages.

The invention therefore provides a holder system comprising a holder providing an opening, an external circumferential band provided towards the upper end of the exterior of the holder, the holder being provided on its outer surface with an engagement means below the circumferential band and a slip ring designed to engage with the engagement means of the holder and further comprising a delivery system attachable to the holder.

In use of such a holder system the slip ring may be placed around a pouch or sachet that is to be attached to the holder, the holder may then be placed in the open end of the pouch or sachet so that the top of the pouch or sachet lies against the external engagement means of the holder. The slip ring may then be engaged with the engagement means of the holder in order to secure the pouch between the exterior surface of the holder and the slip ring. The pouch attached to the holder system is then ready for filling. After use the pouch and the holder system can be separated simply by disengaging the slip ring from the engagement means of the holder. The holder system could be reused while the pouch could be recycled. Alternatively both components could be recycled separately.

The engagement means on the outer surface of the holder may be a screw thread designed to co-operate with a screw thread on the inner surface of the slip ring. Alternatively the slip ring may be a snap and/or push fit around the circumference of the holder. Optionally this can create a seal.

In a preferred embodiment the holder system contains a delivery system for the contents, for example, it may contain a collapsed teat held within the internal space of a collar that is attachable to the holder by means of a manually placeable and removable cap.

The holder carries an external circumferential band at the position on the holder where the top of the open mouth of the pouch should reside so that when applying the pouch around the holder it abuts the base of the circumferential band and the user knows that it is properly located and furthermore the band prevents the collar falling into the pouch. In a further embodiment a seal or gasket may be provided around the base of the exterior of the holder so that when the slip ring is engaged with the holder the seal ensures a hermetic connection between the holder and the slip ring. This combined with a cap which may be provided on the opening provided at the top of the holder can provide a hermetic seal for the liquid contents of the pouch once created allowing hygienic storage and enabling one container filling to be used for more than one infant feed.

The holder component of this invention provides the means for the introduction of material into the pouch and is also detachably attached to the delivery system for the contents of the pouch. In a preferred embodiment where the container is a baby bottle the holder is designed to releasably engage with a delivery system comprising a collar containing a teat. In this embodiment the collar of the delivery system is provided with means for attachment to the holder such as an internal thread which can engage with a thread at the upper end of the holder. When the collar is engaged with the holder it may also form a seal against the slip ring. Alternatively the collar may be a snap fit onto the holder. In either embodiment the holder system includes the delivery teat system which may be in place attached to the holder. The teat system may be removed to allow material such as water to be introduced into the pouch, and may then be replaced so that the filled container is then ready for use.

In this embodiment the teat delivery system preferably comprises the teat and a collar adapted to allow the teat system to be releasably attached to the holder. The teat and the collar may be integrally moulded and where they are of different materials they may be overmoulded. Generally however they are separate enabling the teat to be replaced while retaining the collar. The collar preferably is injection moulded from medical grade polypropylene and the teat being flexible is preferably made from medically acceptable elastomeric material such as Kraton rubber. A liquid tight seal should be formed between the collar and the teat and accordingly where they are separate components it is preferred that the collar be provided with a skirt providing an internal circular rib and the base of the teat is provided with a channel that will engage with the circular rib when the teat is passed through the central orifice of the collar.

As previously mentioned in a particularly convenient design the top of the holder is threaded and the teat is provided attached to a threaded collar so that it can be attached to and removed from the holder.

In a further optional embodiment the holder is provided with wings extending outwardly from a position between the neck of the holder that is attached to the mouth of the bag or pouch and the section that is attached to the collar or teat system. These wings enable the container to be held around the neck of the holder below the wings providing protection from spillage of materials being introduced into the bottle and reducing the risk of contamination of the delivery system during use by contact with the human hand.

In a further embodiment a cap may be provided to protect the delivery system such as a teat from contamination when the container is not in use. Where the delivery system comprises a teat and a collar the cap can be designed to be a removable fit within the internal circumference of the collar. The removable fit may be a snap fit or screw thread preferably a snap fit. In the embodiment where the teat is compressed within the collar and the holder the application of the cap can force the teat to collapse and the underside of the cap may be shaped to provide protection for the teat. The cap may also be provided with a tab to aid its removal from the container. It is preferred that when a cap is employed it is made from medical grade polypropylene.

The holder may also be of any suitable material according to the use to which the container is to be put. The holder should however be sufficiently rigid to provide strength and integrity to the container with which it is used when the container contains the particular liquid for which it is designed. It is preferred that the holder be of a thermoplastic material and is preferably prepared by injection moulding. In particular we have found that polypropylene, ethylene/propylene copolymers, rubbers, thermoplastics elastomers or polyamides are particularly useful materials from which the holder can be made.

In a preferred embodiment of the invention where the container is used for baby feeding the delivery system is a teat system comprising the teat and a collar for attachment of the teat system to the holder. The teat is preferably of a flexible material such as synthetic rubber particularly a silicone rubber or a thermoplastic rubber such as the styrene isoprene block copolymers sold under the trade name Kraton. The teat is preferably collapsed within the collar and the holder and may be released to its useable position by removal of a cap placed over the teat. The teat may be recollapsed within the collar by replacing the cap. In this way the remaining contents of the container may be secured if a feed does not use all the contents. In this way it is possible to recollapse the teat without touching it thus retaining a substantially sterile environment.

In a further embodiment the underside of the cap may be provided with ribs and a cavity to facilitate the compression of the teat as the cap is applied. As a further preferment a stop is provided to ensure that the cap is engaged with the holder to the desired extent and is prevented from over engagement which could result in damage to the teat.

In a further embodiment small protrusions are provided around the inner ring of the holder so that an audible click is produced as the container is assembled to indicate that the components are fully engaged. In another embodiment the slip ring may be provided with indicators of any shape particularly arrows on its external surface showing the way up in which it should be used and the direction it should be moved to engage with the holder. The indicators can also be shaped to provide additional grip for the user.

The invention provides both the kit of components required to assemble the holder system and the holder system comprising the assembled components. Additionally in a further embodiment the invention provides a container comprising a flexible pouch attached to a holder system of this invention.

We prefer the holder to be rigid to allow the optional use of a tamperproof clip, the rigidity allows the clip to apply pressure around the top of the receptacle when attached and it is desirable that the top does not flex under the tension created by the clip. We prefer a cylindrical shape at certain points, but oval and/or tapered are equally desirable. The holder should be able to be held by the human hand which helps to allow the pouch to receive the fluid and maintain a consistent volume.

The holders of this invention may be used with a variety of pouches and sachets such as flex can, push pop, block bottom, pillow shaped and other pouches.

The pouch may or may not be filled with liquid. If the pouch with which the holder system of the present invention is used is not already pre-filled with liquid, preparation of the drink can be achieved as follows. After attachment of the pouch or sachet perhaps containing powdered material to the holder the collar which contains a collapsed mouth piece (which in this example is a teat), may be removed from the holder to expose a filling orifice in the holder. A seal if present over the orifice may be removed. The pouch may then be filled to the desired or pre-measured level with chosen liquid which may include other pre-mixed contents. The delivery system comprising the collar and the collapsed mouthpiece may then be reattached to the holder. If the pouch is pre-filled then it will be sealed and the seal broken once the holder is applied.

Typically, by way of example, for feeding a baby the pouch would have a measured amount of milk powder inside with boiled water to be added as the liquid. After removal of the delivery system and filling the pouch the delivery system typically the teat system including the cap would be replaced and secured to the holder by attaching the collar to the holder. A seal will be created once the delivery system is in the correct position which can be indicated to the user by an audible click. With the fluid delivery tube and cap mechanism still in the sealed position, the contents may then be shaken, stirred, mixed and/or simply left in desired conditions until consumption of contents is required. When consumption is required the cap may be removed so that the mouthpiece resurrects itself to the shape ready for use. After use, a seal may be re-established by positioning the cap over the mouthpiece and applying downward pressure.

Additionally, the delivery system once secured into position by attachment of the collar to the holder forms a seal which is strong enough to prevent leakage. If the contents of the container need to be warmed or cooled the shape of the holder can allow the filled pouch to be immersed in water without the water touching the delivery system or the cover again preserving the sterility of the mouthpiece and contents. If the holder has wings they can be used to hold the pouch in a bath of cooling or heating fluid. It is preferable when changing the temperature of the contents of the container to have the delivery system of the container in the sealed position with the cap in place.

Although the holder system of the present invention have been described primarily in relation to bottles for babies and young children they may be used in a variety of other uses where space saving, single use and disposability are required. For example the system may be used together with pouches or sachets which may or may not be pre-filled to provide liquids such as drinks in military operations, they may also be used in travel such as in space travel or aircraft, in sporting activities and recreational activities such as walking and mountaineering. A further example of the collapsible fluid containers use is for the transport, storage and consumption of medicines to be taken orally and in veterinary applications where a pre-measured amount of material may be placed in a sterilized container which may then be flat packed and easily stored and transported prior to use. The holder system may also be used with containers for storing of oils, paints and the like, where the delivery mechanism may be a brush attachment or sponge. Additionally, using the appropriate fluid delivery tube, the holder can be used with containers the collection of samples such as urine samples for analysis. In other embodiments the holder may be used with containers holding gels, powders and other dissolvable materials.

In such alternate uses delivery systems other than a teat may be used for example the delivery system may comprise a drinking straw provided with a luer lock plate which fit into the collar and has a central orifice which allow the contents to pass into a straw. This allows adult use and also enables ready use of the container in constrained environments. The straw can be flexible and retained within the holder system.

The present invention is illustrated but in no way limited by reference to the accompanying drawings in which

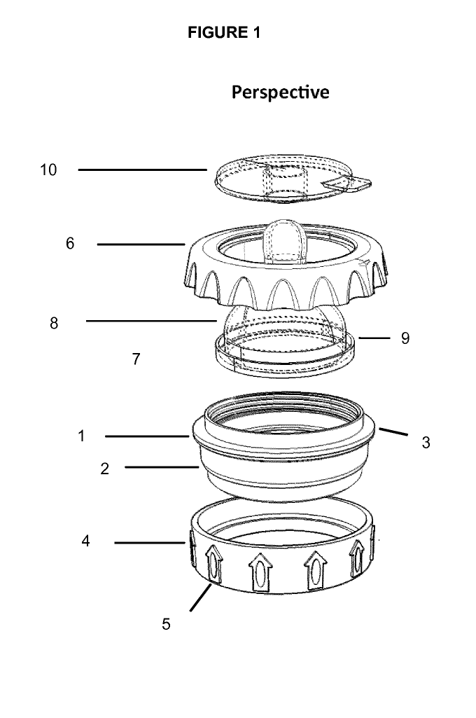

FIG. 1 is an exploded view showing the components of a holder system of the present invention.

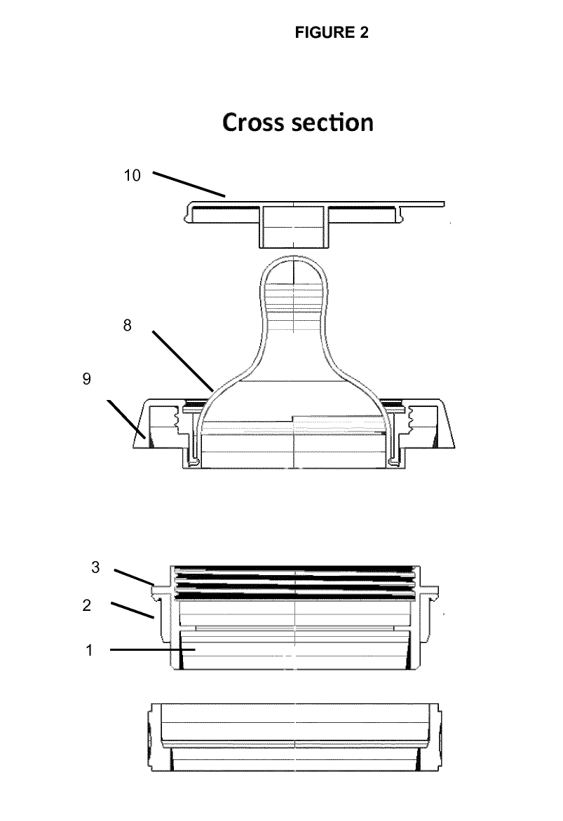

FIG. 2 is a cross section of the components shown in FIG. 1.

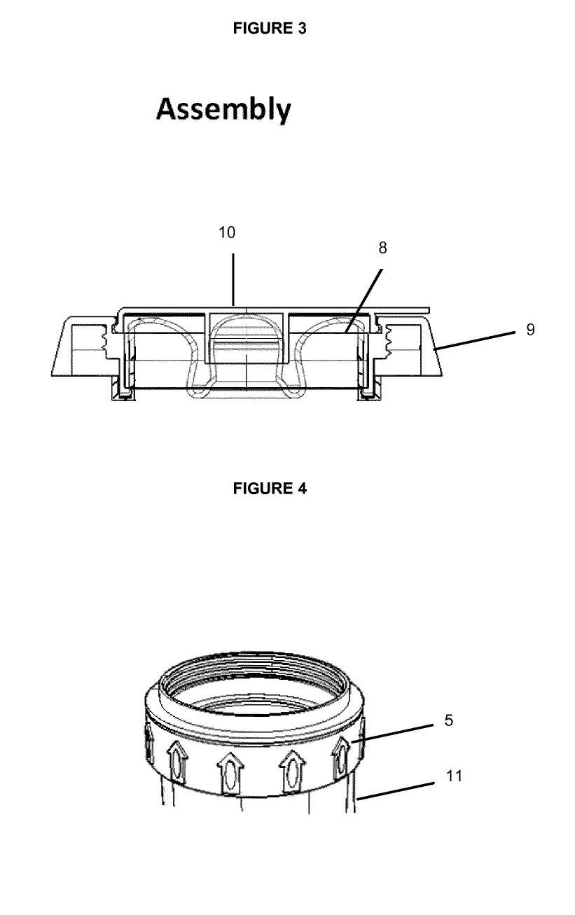

FIG. 2 shows how the various components of the holder system can be assembled to the position shown in FIG. 3.

FIG. 3 shows the teat assembled and held within the collar by the cap.

FIG. 4 shows the slip ring of the holder system around the top of the pouch.

FIG. 5 shows the entire holder system attached to a pouch with the holder system closed.

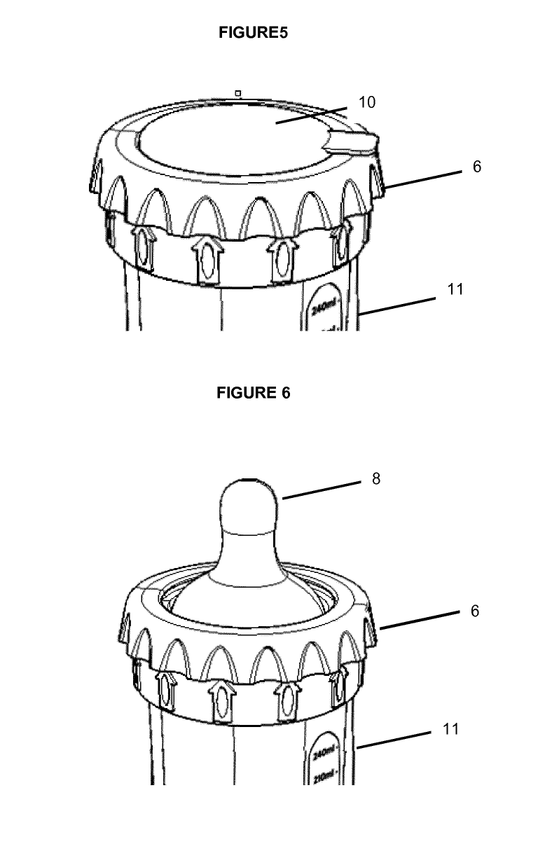

FIG. 6 shows the system of FIG. 5 with the cap removed.

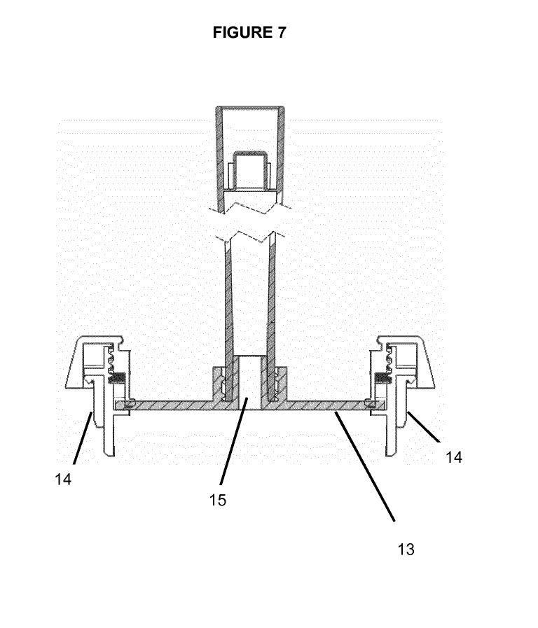

FIG. 7 shows a system of the present invention employing a different delivery system.

With reference to FIG. 1 the holder system comprises a holder (1), provided with a seal (2) and an external circumferential band (3). Additionally the slip ring (4) is provided which can be pressed against the seal (2) in the direction shown by the arrows (5) provided on the slip ring to form a snap fit with the holder. Above the holder is a collar (6) designed to engage with the upper surface (7) of the holder. The figures illustrate a baby bottle and FIG. 1 shows a teat (8) provided with a band (9) at its lower end which engages with a lug inside the holder (1) to provide a tight seal, the cap (10) is placeable in the collar. The attachment of the collar (6) to the holder (1) secures the teat in position as shown in FIG. 2.

FIG. 4 shows how the slip ring (5) may be placed around a pouch or sachet (11) and the holder is then placed in the open mouth (12) of the pouch or sachet as shown in FIG. 5. FIG. 6 shows how the slip ring (4) may then be engaged with the holder (1) and attached to the collar (6) and the cap (10) which securely attaches the mouth (8) of the pouch or sachet against the seal (2). FIG. 7 shows how the cap (10) may be removed from FIG. 6 to allow the teat (8) to protrude from the collar (6) ready for feeding.

FIG. 7 shows a delivery system which comprises a lever lock plate (13) filled into the holder (14) of the holder system of the present invention provided with a covered hole (15) provided with a channel for the insertion of a drink straw.

1. A holder system for a container comprising,
a holder providing an opening,
an external circumferential band provided towards an upper end of an exterior of the holder, the holder provided on its outer surface with an engagement means below the external circumferential band, and
a slip ring designed to engage with the engagement means of the holder, and further comprising a delivery system attachable to the holder.

2. A holder system according to claim 1, wherein the engagement means on the outer surface of the holder is a screw thread designed to cooperate with a screw thread on an inner surface of the slip ring.

3. A holder system according to claim 1, wherein the engagement means comprises a snap and/or push fit of the slip ring around a circumference of the holder.

4. A holder system according to claim 1, wherein the container comprises a pouch or a sachet.

5. A holder system according to claim 1 containing a delivery system for contents of the container.

6. A holder system according to claim 5, wherein the delivery system is a collapsed teat held within an internal space of a collar that is attachable to the holder.

7. A holder system according to claim 4, wherein the external circumferential band is at a position of the holder where a top of an open mouth of a pouch should reside.

8. A holder system according to claim 1, wherein a seal or gasket is provided around a base of the exterior of the holder to engage with the slip ring when it engages with the holder.

9. A holder system according to claim 1, wherein the container is a baby bottle and the holder is releasably engagable with a delivery system comprising a collar containing a teat.

10. A holder system according to claim 9, wherein a liquid tight seal is formed between the collar and the teat.

11. A holder system according to claim 10, wherein the collar is provided with a skirt providing an internal circular rib, and a base of the teat is provided with a channel that engages with a circular rib.

12. A holder system according to claim 1 provided with a removable cap for the delivery system.

13. A holder system according to claim 12, wherein the delivery system comprises a teat and a collar and the cap is a removable fit within an internal circumference of a collar.

14. A holder system according to claim 1, wherein the holder is made from medical grade polypropylene ethylene/propylene copolymers, rubbers, thermoplastics elastomers.

15. A holder system according to claim 1, wherein the slip ring is made from medical grade polypropylene ethylene/propylene copolymers, rubbers, thermoplastics elastomers.

16. A holder system according to claim 6, wherein the collar is made from medical grade polypropylene ethylene/propylene copolymers, rubbers, thermoplastics elastomers.

17. A holder system according to claim 1, wherein the delivery system comprises a straw.

18. A kit of components required to assemble the holder system according to claim 1.

19. A container comprising a flexible pouch attached to the holder system according to claim 1.

20. A process for creation of a liquid within a container comprising:
attaching a pouch or sachet to the holder of the holder system according to claim 1;
filling the pouch to a desired or pre-measured level with a chosen liquid; and
attaching the delivery system to the holder.
